(19) United States
(12) Patent Application Publication
(10) Pub. No.: US 2006/0135634 A1
(43) Pub. Date: Jun. 22, 2006

(54) Low amine emission polyurethane foam

(76) Inventors: Giuliano Guidetti, Capri (IT); Angelo Schiavone, Rio Saliceto (IT); Luigi Pedroni, Carpi (IT)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/545,660

(22) PCT Filed: Mar. 5, 2004
(86) PCT No.: PCT/US04/06644

§ 371 Date: Aug. 15, 2005

Related U.S. Application Data
(60) Provisional application No. 60/453,814, filed on Mar. 11, 2003.

(51) Int. Cl. C08J 9/00

(52) U.S. Cl. 521/99

(57) ABSTRACT

It is found that a polyurethane foam having significantly reduced or negligible amine emissions can be obtained by reacting a polyol with a polyisocyanate in the presence of a blowing agent being a carbamate, obtained from contacting carbon dioxide with an amine or alkanolamine, and further in the presence of a non-fugitive amine catalyst. A process is disclosed which has particular utility for the preparation of integral skinned foam, such as automotive steering wheels, exhibiting attractive physical performance and low volatile amine emissions.

The present invention relates to low emission polyurethane foams, and a process for preparing such foam utilizing a non-fugitive amine-based urethane catalyst and, as blowing agent, a carbamate adduct.

Polyether polyols based on the polymerization of alkylene oxides, and/or polyester polyols, are the major components of a polyurethane system together with isocyanates. These systems generally contain additional components such as cross-linkers, chain extenders, surfactants, cell regulators, stabilizers, antioxidants, flame retardant additives, eventually fillers, and typically catalysts such as tertiary amines and/or organometallic salts. The commonly used tertiary amine catalysts can give rise to undesirable properties of the foam, particularly in flexible, semi-rigid and rigid foam applications. Freshly prepared foams using these catalysts often exhibit the typical odor of the amines and give rise to increased fogging (emission of volatile products).

The presence, or formation, of even traces of tertiary amine catalyst vapors in polyurethane products having vinyl films or polycarbonate sheets exposed thereto can be disadvantageous. Such products commonly appear in automotive interiors as seats, etc. as well as in many domestic applications such as shoe soles, cloth inner liners, appliance, etc. Specifically, the tertiary amine catalysts present in the polyurethane foams have been linked to the staining of the vinyl film and degradation of the polycarbonate sheets. These PVC staining and polycarbonate decomposition problems are especially prevalent in environments where elevated temperatures exist for long periods of time.

Various solutions to this problem have been proposed. For instance, U.S. Pat. No. 4,517,313 discloses the use of the reaction product of dimethylaminopropylamine and carbonic acid as a catalyst for use in the manufacture of polyurethane. The use of this catalyst is stated to reduce odor and vinyl staining relative to the use of standard triethylenediamine catalysts. However this amine catalyst cannot match the performance of a standard catalyst such as triethylenediamine in polyurethane curing since it is a much weaker catalyst. EP 176,013 discloses the use of specific aminoalkylurea catalysts in the manufacture of polyurethanes. Use of these catalysts is also said to reduce odor and vinyl staining through the use of relatively high molecular weight amine catalysts.

Use of amine catalysts which contain a hydrogen isocyanate reactive group such as a hydroxyl or a primary and/or a secondary amine are proposed by catalyst suppliers. One such compound is disclosed in EP 747,407. A reported advantage of the catalyst composition is they are incorporated into the polyurethane product. However those catalysts usually have to be used at high levels in the polyurethane formulation to compensate for their lack of mobility during the reactions to get normal processing conditions. As a result generally not all of these molecules have time to react with isocyanates and some traces of free amine are typically present in the final product, especially in the case of fast gelling and fast curing systems.

Therefore, there continues to be a need for alternative means to control vinyl staining and polycarbonate decomposition by polyurethane compositions. It is an object of the present invention to produce polyurethane products containing a reduced level of conventional tertiary amine catalysts and a reduced level of reactive amine catalysts.

Integral skin foams are well known to those skilled in the art of polyurethane foams. Such foams have a cellular interior and a higher density microcellular or non-cellular skin. In general, to prepare such foams an organic isocyanate is reacted with a substance having at least one isocyanate reactive group in the presence of a catalyst, blowing agent, and a variety of optional additives. The reaction is carried out in a mold where a higher density skin forms at the interface of the reaction mixture and the relatively cool inner surface of the foam.

Traditionally the blowing agent used in integral skin polyurethane foams have been physical blowing agents including chlorofluorocarbons (CFCs) or combinations of CFCs and other blowing agents or more recently hydrofluoroalkanes or hydrocarbons. U.S. Pat. No. 5,506,275 describe the use of 1,1,1,2-tetrafluoroethane (HFC 134a) as blowing agent in integral skin foam formulations. U.S. Pat. Nos. 5,906,999 and 6,010,649 disclose the use of pentafluoropropane blowing agents, particularly 1,1,1,3,3-pentafluoropropane for producing integral skin foams. The pentafluoropropane blowing agents are reported to give acceptable appearance and exhibit enhanced resistance to abrasion and cracking. Such blowing agents are more costly and not always conveniently available.

As an alternative to physical blowing agents, chemical or reactive blowing agents such as water has been employed but frequently provides a hard foam of unattractive physical properties. Another alternative chemical blowing agent involves the use of carbamates, adducts of carbon dioxide with an amine or an alkanolamine. Such adducts and process employing such adducts to produce polyurethane foam are disclosed in for example U.S. Pat. Nos. 4,500,656; 5,288,766; 5,464,880; 5,789,451; 5,760,098; 6,316,662; 6,326,412; and 6,343,559.

While there are many chemistries available for the manufacture of polyurethane foam and integral skinned products there still remains a need to provide a system which gives polyurethane foam, and notably integral skinned polyurethane articles, of attractive physical properties; provides a foam characterized by low emissions; and provides a foam via a process that is acceptable from the aspects of economy and environment.

The present invention presents a process for preparing a polyurethane foam having a reduced volatile emission by reacting a polyisocyanate with a polyether polyol or polyester polyol in the presence of a blowing agent and a urethane-promoting catalyst wherein:

a) the blowing agent comprises a carbamate adduct obtained by contacting carbon dioxide with an amine or alkanolamine; and

b) the catalyst comprises a non-fugitive amine catalyst.

In another embodiment, the present invention is a polyurethane foam obtained according to the aforementioned process.

In a further embodiment, the present invention is a two component system suitable for manufacture of low emission polyurethane foam which comprises as first component, a polyisocyanate component and as second component a polyol composition, said composition comprising:
a) a polyether or polyester polyol;
b) a carbamate adduct obtained by contacting carbon dioxide with an amine or alkanolamine; and

c) a urethane promoting catalyst being a non-fugitive amine.

In yet another embodiment, the present invention is a polyol composition suitable for reacting with a polyisocyanate to give a low emission polyurethane foam wherein said composition comprises:
a) a polyether or polyester polyol;
b) a carbamate adduct obtained by contacting carbon dioxide with an amine or alkanolamine; and
c) a urethane promoting catalyst being a non-fugitive amine.

The polyurethane foam of this present invention is obtained by reacting a polyisocyanate with a polyol in the presence of a blowing agent and a catalyst. It is found that by using a blowing agent which comprises a carbamate being a carbon dioxide adduct of an amine or alkanolamine; in combination with a catalyst which comprises a non-fugitive amine urethane catalyst, produces a foam characterized by low volatile amine emissions is obtained.

The carbamate used as blowing agent can be any adduct of carbon dioxide with an amine or alkanolamine. Such adducts are well known and described in the literature including U.S. Pat. Nos. 4,500,656; 5,288,766; 5,464,880; 5,789,451; 5,760,098; 5,559,285; 6,316,662; 6,326,412; and 6,343,559. Particularly preferred carbamates for use in the present invention can be obtained by contacting carbon dioxide with an alkanolamine wherein the alkanolamine is a substance containing one or two ether moieties per molecule. Use of such an alkanolamine provides firstly, for adducts which are liquid at room temperature; secondly, for adducts that have a viscosity convenient for the manufacture of polyurethane polymer; and thirdly, for adducts that are able to release an attractive amount of carbon dioxide. The alkanolamine can be a secondary amine but preferably is a primary amine. Primary amines exhibit a greater reactivity with respect to formation of the carbamate. When the alkanolamine is a primary amine it is characterized by the following general formula,
H₂N—(CHR′—CHR″—O)ₙ—(CH₂)ₓ—OH

or when the alkanolamine is a secondary amine it is characterized by the following general formula 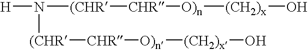
wherein, independently, R′ is hydrogen, methyl or ethyl; R″ is hydrogen, methyl or ethyl; the integer n or n′ is 0, 1 or 2 with the proviso that the sum of n and n′ is at least 1 but less than 3; and the integer x or x′, is a whole number of from 1 to 4. Exemplary of a suitable and preferred alkanolamine is the primary amine 2-(2-aminoethoxy)ethane or 2-(2-(2-aminoethoxy)ethoxy)ethanol. The preferred carbamates are described in more detail in U.S. Pat. Nos. 5,789,451 and 5,859,285

By non-fugitive urethane catalyst it is understood a substance which is able to promote the formation of urethane from the reaction of isocyanate with a polyol wherein such catalyst by virtue of bearing an isocyanate reactive moiety ultimately becomes bound and fixed into the resulting urethane polymer. In this present invention the non-fugitive urethane catalyst is a reactive amine catalyst, preferably a tertiary amine catalyst, having as reactive moiety a hydroxyl, a primary or secondary amine group, or thiol. Preferred as non-fugitive amine catalysts for this invention are those substances that are tertiary amine catalysts having an amine group as the reactive moiety. Exemplary of suitable reactive amine catalysts bearing a hydroxyl group include N,N,N′-trimethyl-N-hydroxyethyl-bisaminoethyl ether commercially available as JEFFCAT ZF-10; N,N-bis (3-dimethylaminopropyl)-N-isopropanol amine commercially available as JEFFCAT ZR-50 ; N-(3-dimethylaminopropyl)-N,N-diisopropanolamine commercially available as JEFFCAT DPA; N,N-dimethylethanolamine commercially available as JEFFCAT DMEA; 2-(2-dimethylaminoethoxy) ethanol commercially available as JEFFCAT ZR-70; all available from Huntsman Corp. Other suitable reactive amine catalysts bearing a hydroxyl group are as mentioned in the published patent application US 2002/0025989, column paragraphs 17 and 18 Illustrative of reactive amine catalysts bearing an amine group includes 3-dimethylaminopropylurea and 3-dimethylaminopropylamine and adducts thereof. Exemplary of commercially available reactive amine catalysts understood as having an amine reactive moiety include the following proprietary products DABCO NE200 and DABCO NE1060 available from Air Products; and TOYOCAT RX20, TOYOCAT RX21 and TOYOCAT RX30 available from the Tosoh Corporation. The non-fugitive amine catalyst is present in an effective amount for the purpose of preparing the polyurethane foam. Such amount will be dependent on the nature and reactivity of the materials and reactants present but typically is from 0.01 to 3 parts, preferably from 0.1 to 2.5 parts, and more preferably in from 0.2 to 2 parts by weight per 100 parts by weight of polyol.

The isocyanates that may be used in the present invention are aromatic polyisocyanates. Examples of suitable aromatic isocyanates include the 4,4′-, 2,4′and 2,2′-isomers of diphenylmethane diisocyanate (MDI), blends thereof and polymeric and monomeric MDI blends toluene-2,4- and 2,6-diisocyanates (TDI), m- and p-phenylenediisocyanate, chlorophenylene-2,4-diisocyanate, diphenylene-4,4′-diisocyanate, 4,4′-diisocyanate-3,3′-dimehtyldiphenyl, 3-methyldiphenyl-methane-4,4′-diisocyanate and diphenyletherdiisocyanate and 2,4,6-triisocyanatotoluene and 2,4,4′-triisocyanatodiphenylether.

Mixtures of isocyanates may be used, such as the commercially available mixtures of 2,4- and 2,6-isomers of toluene diisocyanates. A crude polyisocyanate may also be used in the practice of this invention, such as crude toluene diisocyanate obtained by the phosgenation of a mixture of toluene diamine or the crude diphenylmethane diisocyanate obtained by the phosgenation of crude methylene diphenylamine. TDI/MDI blends may also be used. Prepolymers based on the polyisocyanates can also be used. Isocyanate-terminated prepolymers are prepared by reacting an excess of polyisocyanate with polyols, including aminated polyols or imines/enamines thereof, or polyamines.

Especially useful, due to their availability and properties, are 2,4′-diphenyl diisocyanate, 4,4′-diphenylmethane diisocyanate, polymethylene polyisocyanate and mixtures thereof. Mixtures of polymeric diphenylmethane diisocyanate (polymeric MDI) and carbodiimide or urethane modified MDI are preferred. The polyisocyanate is generally added in an amount to provide an isocyanate index between 80 and 125, preferably between 100 to 110.

The polyol component includes those materials having two or more groups containing an active hydrogen atom capable of undergoing reaction with an isocyanate. Preferred among such compounds are materials having at least two hydroxyl, primary or secondary amine, carboxylic acid, or thiol groups per molecule Compounds having at least two hydroxyl groups per molecule are especially preferred due to their desirable reactivity with polyisocyanates.

The hydroxyl number and molecular weight of the polyol can vary according to the desired property of the cellular foam. In general the hydroxyl number will range from 20 to 800. In applications for producing flexible articles, typically polyols include those having an average hydroxyl number ranging from 20 to 100 mg KOH/g, preferably from 20 to 70 mg KOH/g. Such polyols also advantageously have a functionality between 1.5 and 4, preferably between 2 and 3. Generally the number average molecular weight is 2,000 to 10,000, preferably from 3000 to 6000 and more preferred from 3500 to 5100. For applications for producing rigid articles, typically polyols include those having an average molecular weight of 60 to 10,000, preferably 600 to 7,000 and more preferred from 600 to 3,000. Such polyols also advantageously have a functionality between 2 and 6, preferably between 2 and 4.

Representative polyols include polyether polyols, polyester polyols, polyhydroxy-terminated acetal resins, hydroxyl-terminated amines and polyamines. Examples of these and other suitable isocyanate-reactive materials are described more fully in U.S. Pat. No. 4,394,491.

Preferred are polyether polyols prepared by adding an alkylene oxide, such as ethylene oxide, propylene oxide, butylene oxide or a combination thereof, to an initiator having from 2 to 8, preferably 3 to 6 active hydrogen atoms. Examples of suitable initiator molecules for polyether or polyester polyols include water, organic dicarboxylic acids, such as succinic acid, adipic acid, phthalic acid and terephthalic acid and polyhydric, in particular dihydric to octahydric alcohols or dialkylene glycols, for example, ethanediol, 1,2- and 1,3-propanediol, diethylene glycol, dipropylene glycol, 1,4-butanediol, 1,6-hexanediol, glycerol, trimethylolpropane, pentaerythritol, sorbitol and sucrose or blends thereof. Other initiators include linear and cyclic compounds containing a tertiary amine such as ethanoldiamine, triethanoldiamine, and various isomers of toluene diamine. Catalysts for polymerization of alkylene oxides with the initiator can be either anionic or cationic. Representative examples of such catalysts are KOH, CSOH, boron trifluoride or a double cyanide complex (DMC) catalyst such as zinc hexacyanocoboltate. A further class of polyol than can also be used to advantage when intending to prepare low emission polyurethane foams are the auto-catalytic amine-based polyether polyols such as disclosed in the patent publication WO 02/22702 and U.S. Pat. No. 5,476,969 Preferred auto-catalytic amine-based polyols are those obtained by reacting N-methyl-1,3-propanediamine or N,N-dimethyl-tris(hydroxymethyl)-aminomethane with propylene and/or ethylene oxide to provide a polyol having a hydroxyl equivalent weight of from 500 to 2500, and preferably from 1000 to 2000. When present such polyol advantageously constitutes from 5 to 60, preferably from 10 to 50 parts per 100 parts by weight of the total polyol composition.

The polyol may have incorporated therein copolymer polyols of vinyl monomers in a continues polyol phase, particularly dispersions of styrene/acrylonitrile (SAN) copolymers. Polyisocyanate polyaddition (PIPA) polyols (dispersions of polyurea-polyurethane particles in a polyol) and the polyurea dispersions in polyols (PHD polyols). Such polyols are described in Polyurethane Handbook, by G., Oertel, Hanser publishers, and U.S. Pat. Nos. 3,932,092; 4,014,846; 4,093,573 and 4,122,056, and EP Publications 0 418 039 B1 and EP 0 687 279 B1.

In addition to the aforementioned components optionally but advantageously present when preparing the polyurethane foam of this invention can be physical blowing agents, processing aids including surfactants, non-amine catalysts and fillers.

While the present invention contemplates the use of the carbamate adduct as the principle, and in a preferred embodiment the sole blowing agent, other physical blowing agents may be present. Such physical blowing agents can include hydrofluoroalkanes such as, for example, tetrafluoroethane, pentafluoropropane, pentafluorobutane, or heptafluoropropane; or hydrocarbons such as for example n-pentane, iso-pentane, and cyclopentane. The carbamate, and optional physical blowing agent is generally present in an amount sufficient to provide foam having molded densities of from 100 kg/m3 to 1000 kg/m3, preferably from 300 kg/m³ to 700 kg/m³ and more preferably from 400 kg/m³ to 600 kg/m³. Typically to produce foam of such density the carbamate is present in an amount of from 0.1 to 10, preferably from 0.5 to 7 and more preferably from 1.5 to 5 parts per 100 parts by weight of polyol.

In a particularly preferred embodiment of the invention, the process provides for an integral skin foam where the blowing agent consists essentially of the aforementioned carbamate adduct. Water may be present in small amounts but primarily for the purpose of aiding the processing and cure of the system, rather than as a chemical blowing agent. In this instance, the amount of water present generally will not exceed 0.75, and preferably not excess 0.5 parts per 100 parts by weight of polyol. Higher amounts of water give hard foam and may be detrimental to the attainment of low emission foam.

The mechanical parameters of the current process are flexible and depend on the final application of the integral skin polyurethane foam. The reaction system is versatile enough that it may be made in a variety of densities and hardness. The system may be introduced into a mold in a variety of ways known to those skilled in the art. It may be shot into a preheated closed mold via high-pressure injection technique. In this manner, it processes well enough to fill complex molds at low mold densities (from 300 kg/m³ to 400 kg/m³). It may also be run using a conventional open mold technique wherein the reaction mixture or system is poured or injected relatively at low pressure or atmospheric pressure into a preheated open mold. In the instant process, the system may be run at mold temperatures from room temperature to 50° C. with room temperature being preferred.

In addition to the foregoing critical components, it is often desirable to employ certain other ingredients in preparing polyurethane polymers. Among these additional ingredients are surfactants, plasticizers such as gamma butylactone, preservatives, alcohols, flame retardants, fungistatic and/or bacteriostatic, colorants, antioxidants, reinforcing agents, stabilizers and fillers.

While surface active agents or surfactants are generally not needed to solubilize the blowing agent of the present invention, they may be employed to stabilize the foaming reaction mixture until it cures or to regulate the cell size and structure of the resulting foam. Such surfactants advantageously comprise a liquid or solid organosilicone surfactant. Other surfactants include polyethylene glycol ethers of long-chain alcohols, tertiary amine or alkanolamine salts of long-chain alkyl acid sulfate esters, alkyl sulfonic esters and alkyl arylsulfonic acids. Such surfactants are employed in amounts sufficient to stabilize the foaming reaction mixture against collapse and the formation of large, uneven cells. Typically, 0.2 to 3 parts of the surfactant per 100 parts by weight total polyol (b) are sufficient for this purpose. Other examples of surface active components include paraffinoils, castor oil esters, phthalic acid esters, ricindolic acid esters and Turkey red oil.

When appropriate to enhancing the processing and curing of the polyurethane foam additional urethane catalysts may be present. Such additional catalysts preferably are non-amine compounds and to advantage organometallic compounds. Exemplary organometallic catalysts include organomercury, organolead, organoferric, organotitaniun, and organotin catalysts, with organotin catalysts being preferred among these. Suitable tin catalysts include stannous chloride, tin salts of carboxylic acids such as dibutyltin di-laurate, as well as other organometallic compounds such as are disclosed in U.S. Pat. No. 2,846,408. A catalyst for the trimerization of polyisocyanates, resulting in a polyisocyanurate, such as an alkali metal alkoxide may also optionally be employed herein. The amount of organometallic catalyst typically is from from 0.001 to 2, preferably from 0.01 to 1 part per 100 parts by weight of polyol.

A crosslinking agent or a chain extender may be added, if necessary. The crosslinking agent or the chain extender includes low-molecular polyhydric alcohols such as ethylene glycol, diethylene glycol, 1,4-butanediol, and glycerin; low-molecular amine polyol such as diethanolamine and triethanolamine; polyamines such as ethylene diamine, xlylenediamine, and methylene-bis(o-chloroaniline). The use of such crosslinking agents or chain extenders is known in the art as disclosed in U.S. Pat. Nos. 4,863,979 and 4,963,399 and EP 549,120.

A flame retardant can be added to the formulations, particularly in formulations for producing structural rigid foams. Any known liquid or solid flame retardant can be used. Generally such flame retardant agents are halogen-substituted phosphates and inorganic flame proofing agents. Common halogen-substituted phosphates are tricresyl phosphate, tris(1,3-dichloropropyl phosphate, tris(2,3-dibromopropyl) phosphate and tetrakis (2-chloroethyl)ethylene diphosphate. Inorganic flame retardants include red phosphorous, aluminum oxide hydrate, antimony trioxide, ammonium sulfate, expandable graphite, urea or melamine cyanurate or mixtures of at least two flame retardants. In general, when present, flame retardants are added at a level of from 5 to 50 parts by weight, preferable from 5 to 25 parts by weight of the flame retardant per 100 parts per weight of the total polyol present.

The applications for integral skin foams produced by the present invention are those known in the industry. For example they find use in applications such as furniture, shoe soles, automobile seats, sun visors, steering wheels, armrests, door panels, noise insulation parts and dashboards.

Processing for producing such polyurethane products are well known in the art. In general components of the polyurethane-forming reaction mixture may be mixed together in any convenient manner, for example by using any of the mixing equipment described in the prior art for the purpose such as described in Polyurethane Handbook, by G. Oertel, Hanser publisher.

The following examples are given to illustrate the invention and should not be interpreted as limiting in anyway. Unless stated otherwise, all parts and percentages are given by weight.

A description of the raw materials used in the examples is as follows.

Polyol 1

A glycerine initiated polyoxypropylene-polyoxyethylene (12 wt percent end capped) polyol having an average hydroxyl number of 35, available from The Dow Chemical Company.

Polyol 2

A polyoxypropylene-polyoxyethylene (10 wt percent end capped) polyether diol having an average hydroxyl number of 56, available from The Dow Chemical Company.

Polyol 3

A glycerine initiated polyoxypropylene-polyoxyethylene polyol containing 40 percent of grafted styrene/acrylonytrile polymer and having an overall average hydroxyl number of 32, available from The Dow Chemical Company.

Polyol 4

An autocatalytic polyether of 1700 equivalent weight being a propoxylated triol with 15 percent EO end capping initiated with N,N-dimethyl-tris(hydroxymethyl)-aminomethane; available from The Dow Chemical Company.

EG ethylene glycol
Catalyst 1 a tin catalyst FORMERZ UL38 available from Crompton and understood to be dioctyltin dicarboxylate.
Catalyst 2 a reactive amine catalyst TOYOCAT RX20 available from the Tosoh Corporation
Catalyst 3 a reactive amine catalyst TOYOCAT RX21 available from the Tosoh Corporation
Catalyst 4 a reactive amine catalyst DABCO NE 200 available from the Air Product.
Catalyst 5 a reactive amine catalyst DABCO NE 1060 available from the Air Product.
Carbamate 1 A carbamate adduct obtained by adding carbon dioxide (105 parts by weight) to a mixture of ethylene glycol, 500 pbw, and 2-(2-aminoethoxy) ethanol, 500 pbw.
Black Paste is a carbon black dispersion in polyether polyol (20:80); average OH number of 35.
POLYISOCYANATE 1 is a urethane-modified polyisocyanate having an isocyanate content of 28 weight percent and is obtained by reaction of tripropylene glycol with a mixture of methylene diphenylisocyanate and polymethylene polyphenyl polyisocyanate available from The Dow Chemical Company.
POLYISOCYANATE 2 is a prepolymer obtained by reaction of 4,4′- methylene diphenylisocyanate with tripropylene glycol and blended with a carbodiiamide modified adduct of 4-4′MDI and has an isocyanate content of 26 weight percent, available from The Dow Chemical Company.

### EXAMPLES 1-5

An integral skinned polyurethane article, an automotive steering wheel, was prepared according to the formulations given in Table 1 by mixing the reactants with a high pressure dispenser equipped with a Cannon A40, 14 mm, FPL mixing head and injecting into a mold. The reaction components being at a temperature of about 30° C.; and the mold at about 50° C. The article is removed from the mold after approximately 2 minutes.

Volatile amine emissions are measured according to test procedure PV 3937 issued by Volkswagen AG. In brief this test requires placing a PVC sample strip in a sealed glass tank and visually observing any color change or surface stain occurring after 72 hours at 100° C. The test is conducted in the presence and absence of a sample of the polyurethane foam to provide controlled conditions. The PVC sample is a standard test material available from Benecke-Kaliko, Hanover, Germany under article number 6,025,373.

TABLE 1

| | EXAMPLE | EXAMPLE | EXAMPLE | Example | EXAMPLE |
|---|---|---|---|---|---|
| INGREDIENTS | 1* | 2* | 3 | 4 | 5 |
| Polyol 1 | 59.33 | 60.29 | 73.14 | 31.80 | 51.80 |
| Polyol 2 | | | 13.60 | | |
| Polyol 3 | 27.25 | 27.25 | | 18.00 | 18.00 |
| Polyol 4 | | | | 40.00 | 20.00 |
| Ethylene Glycol | 6.81 | 6.81 | 5.80 | 5.80 | 5.80 |
| Catalyst 1 | | | 0.01 | | 0.005 |
| Catalyst 2 | | 1.85 | 1.17 | 1.04 | 1.04 |
| Catalyst 3 | | 0.10 | | 0.09 | 0.09 |
| Catalyst 4 | 0.33 | | | | |
| Catalyst 5 | 2.58 | | | | |
| Carbamate 1 | | | 3.17 | 3.17 | 3.17 |
| Black Paste | 3.00 | 3.00 | 2.,90 | 2.90 | 2.90 |
| Water | 0.70 | 0.70 | 0.20 | 0.2 | 0.20 |
| Total formulated polyol p.b.w. | 100.00 | 100.00 | 100.00 | 100.00 | 100.00 |
| Polyisocyanate 1 p.b.w. | | | 50 | 50 | 50 |
| Polyisocyanate 2 p.b.w. | 63 | 60 | | | |
| Mould dens. Kg/M³ | 400 | 400 | 400 | 400 | 400 |
| Mold Temp. ° C. | 50 | 50 | 50 | 50 | 50 |
| Hardness: Shore A | 70 | 70 | 60 | 70 | 65 |
| Emissions according to | Fail | Fail | Pass | Pass | pass |
| Test Procedure PV 3937 | | | | | |

*Comparative Examples

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

What is claimed is:

1. A process for preparing a polyurethane foam, having a reduced volatile emission, by react a polyisocyanate with a polyether polyol or polyester polyol in the presence of a blowing agent and a urethane-promoting catalyst wherein:
a) the blowing agent comprises a carbamate adduct obtained by contacting carbon dioxide with an amine or alkanolamine; and
b) the catalyst comprises a non-fugitive amine catalyst.

2. The process of claim 1 wherein the polyurethane foam has an integral skin.

3. The process of claim 2 wherein the carbamate is obtained by contacting carbon dioxide with an alkanolamine wherein the alkanolamine is a substance containing one or two ether moieties per molecule.

4. The process of claim 3 wherein the alkanolamine corresponds to one of the following formulae, 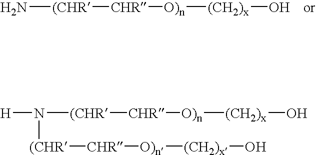
wherein, independently, R′ is hydrogen, methyl or ethyl; R″ is hydrogen, methyl or ethyl; the integer n or n′ is 0, 1 or 2 with the proviso that the sum of n and n′ is at least 1 and less than 3; and the integer x or x′ is a whole number of from 1 to 4.

5. The process of claim 3 wherein the alkanolamine is 2-(2-aminoethoxy)ethanol or 2-(2-(2-aminoethoxy)-ethoxy)-ethanol.

6. The process of claim 1 wherein the non-fugitive amine catalyst is a tertiary amine compound bearing as reactive moiety a hydroxyl, or a primary or secondary amine group.

7. The process of claim 6 wherein the non-fugitive amine catalyst is a tertiary amine compound bearing as reactive moiety a primary or secondary amine group.

8. The process of claim 1 wherein further present is an organometallic urethane-promoting catalyst.

9. The process of claim 8 wherein the organometallic urethane-promoting catalyst is a tin catalyst.

10. The process of claim 1 wherein
a) the blowing agent is a carbamate obtained by contacting carbon dioxide with an alkanolamine wherein the alkanolamine is a substance containing one or two ether moieties per molecule;
b) the non-fugitive amine catalyst is a tertiary amine compound bearing as reactive moiety a primary or secondary amine group; and further present is
c) an organometallic urethane-promoting catalyst containing tin.

11. The process of claim 2 wherein:
a) the blowing agent consists essentially of a carbamate obtained by contacting carbon dioxide with an alkanolamine wherein the alkanolamine is a substance containing one or two ether moieties per molecule;
b) the non-fugitive amine catalyst is a tertiary amine compound bearing as reactive moiety a primary or secondary amine group; and further contains
c) an organometallic urethane-promoting catalyst containing tin.

12. A cellular polyurethane obtained according to the process of claim 1.

13. A molded cellular polyurethane characterized in that the foam has an integral skin and wherein said foam is obtained according to the process of claim 2.

14. A molded cellular polyurethane characterized in that the foam has an integral skin and wherein said foam is obtained according to the process of claim 11.

15. A two component system suitable for manufacture of low emission polyurethane foam having as first component a polyisocyanate and as second component a polyol composition, said composition comprising
a) a polyether or polyester polyol;
b) a carbamate adduct obtained by contacting carbon dioxide with an amine or alkanolamine; and
c) a urethane promoting catalyst being a non-fugitive amine.

16. The two component system of claim 15 where in the polyol composition further comprises an organometallic urethane-promoting catalyst containing tin.

17. A polyol composition suitable for reacting with a polyisocyanate to give a low emission polyurethane foam wherein said composition comprises:
a) a polyether or polyester polyol;
b) a carbamate adduct obtained by contacting carbon dioxide with an amine or alkanolamine; and
c) a urethane promoting catalyst being a non-fugitive amine.

18. The polyol composition of claim 17 which further comprises an organometallic urethane-promoting catalyst containing tin.

19. The polyol composition of claim 17 having present a polyether polyol which is an auto-catalytic amine-based polyol.

20. The polyol composition of claim 19 wherein the auto-catalytic amine-based polyol is present in an amount of from 5 to 60 parts per 100 parts by weight of the total polyol composition.
